(19) United States
(12) Patent Application Publication
(10) Pub. No.: US 2021/0053455 A1
(43) Pub. Date: Feb. 25, 2021

(54) Systems and Methods for Underside Charging of Electrical Vehicles

(71) Applicant: ABB Schweiz AG, Baden (CH)

(72) Inventors: Thomas A. Fuhlbrigge, Ellington, CT (US); Gregory A. Cole, West Hartford, CT (US); William J. Eakins, Coventry, CT (US); Sangeun Choi, Simsbury, CT (US); Martin Krucinski, Glastonbury, CT (US)

(73) Assignee: ABB Schweiz AG, Baden (CH)

(21) Appl. No.: 16/547,218

(22) Filed: Aug. 21, 2019

(51) Int. Cl. B60L 53/31; B60L 53/36; B60L 53/30; B60L 53/66; B60L 53/16

(52) U.S. Cl. CPC B60L 53/31; B60L 53/36; B60Y 2200/91; B60L 53/66; B60L 53/16; B60L 53/305

(57) ABSTRACT

Systems and method for underside charging of electric vehicles (EVs) are provided. With the EV positioned in a charging environment having a ground surface, a floor unit device actuates an electrical connector toward a charge receptacle of an EV vehicle unit, and the vehicle unit actuates the charge receptacle toward the electrical connector. The actuation facilitates coupling between the connector and the charge receptacle. A flow of electrical current is initiated through the coupled connector and charge receptacle to charge the EV power storage device. Upon completion of the EV charging process, the electrical connector and the charge receptacle are actuated away from one another to facilitate decoupling therebetween.

### TECHNICAL FIELD

The present disclosure relates to charging systems and methods for electric vehicles and, more particularly, to systems and methods for effecting an electrical connection between a vehicle charger and the vehicle.

### BACKGROUND

Use of electrical vehicles is becoming increasingly popular due to the environmental benefits of removing pollution caused by fossil fuel burning vehicle engines from the environment, especially in densely populated urban environments. As with most mobile electrical devices, electrical vehicles carry electrical power storage devices or batteries, which provide power to the vehicle propulsion and other systems. As can be appreciated, the vehicle batteries require periodic recharging to provide consistent vehicle operation.

At present, electric vehicle recharging is a time consuming process that is typically carried out over long periods, for example, overnight or during prolonged periods when the electric vehicle is parked. Power dispensers include flexible conduits or wire bundles that include a connector at their end, which plugs into a vehicle receptacle and then begins the transfer of power from the dispenser the vehicle's battery.

Traditional vehicle power dispensers operate at around 200-240 Volt AC, and transfer about 30 Amp of electrical power into a vehicle. As a consequence, providing a full charge to a vehicle can take up to 10 hours or more. With the increase in popularity of electric vehicles, faster charging solutions which are easier and safer to operate, and which can be retrofitted into existing fully electric or hybrid electric vehicles and facilities are required.

### SUMMARY OF THE DISCLOSURE

The below-described systems and methods for underside charging of EVs provide space- and weight-efficient mechanisms for efficient, reliable and safe charging operations. As compared to known systems and methods, the embodiments disclosed herein provide a number of technical benefits and user advantages in a wide variety of operational environments ranging from home use to commercial contexts. By employing simple yet robust components and other design elements, the disclosed systems and methods for underside charging or EVs are easy to maintain and they may be cost-effectively retrofitted into existing electric vehicles and facilities.

In one aspect, the disclosure describes a floor unit device for charging an electric vehicle (EV). The floor unit device includes a floor unit link having a distal end and a proximal end. The floor unit device includes an electrical connector operably coupled to the floor unit link proximal the distal end thereof. The electrical connector is electrically coupled to a power source positioned outside of the EV. The floor unit device includes a floor unit actuator operably coupled to the floor unit link proximal the proximal end thereof. The floor unit actuator alternately moves the floor unit link toward and away from the EV to facilitate alternately connecting and disconnecting the connector from a charge receptacle of the EV.

In another aspect, the disclosure describes a system for charging an EV in an EV charging environment. The charging environment has a ground surface. The EV includes an EV underside positioned opposite the ground surface. The system includes a floor unit device positioned on or at least partially in the ground surface. The floor unit device includes a floor unit link having a distal end and a proximal end. The floor unit device includes an electrical connector operably coupled to the floor unit link proximal the distal end thereof. The electrical connector is electrically coupled to a power source positioned outside of the EV. The floor unit device includes a floor unit actuator operably coupled to the floor unit link proximal the proximal end thereof. The system includes a vehicle unit device positioned on or at least partially in the EV underside. The vehicle unit device includes a vehicle unit link having a distal end and a proximal end. The vehicle unit device includes a charge receptacle operably coupled to the vehicle unit link proximal the proximal end thereof. The charge receptacle is electrically coupled to a power storage device of the EV. The vehicle unit device includes a vehicle unit actuator operably coupled to the vehicle unit link proximal the distal end thereof. The floor unit and vehicle unit actuators alternately move the floor unit and vehicle unit links toward and away from one another to facilitate alternately connecting and disconnecting the connector to and from the charge receptacle, respectively.

In yet another aspect, the disclosure describes a method for charging an EV. The method includes positioning a floor unit electrical connector with reference to a vehicle unit charge receptacle. The method includes actuating the connector and the charge receptacle toward one another to effect a coupling therebetween. The connector and the charge receptacle are actuated toward one another in response to the connector being positioned with reference to the charge receptacle. The method includes initiating an EV charging process by selectively enabling a flow of electric current from an electric power supply through the coupled connector and charge receptacle to a power storage device of the EV.

Further and alternative aspects and features of the disclosed principles will be appreciated from the following detailed description and the accompanying drawings. As will be appreciated, the principles related to devices, systems, and methods for charging of EVs disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIGS. 1A, 1B, 1C and 1D are perspective and schematic views of an electric vehicle (EV) charging environment according to an embodiment of the disclosure.

FIG. 2 is a flowchart of a method for underside charging of EVs according to an embodiment of the disclosure.

FIGS. 3A and 3B are schematic diagrams of a system for underside charging of EVs according to an embodiment of the disclosure.

FIGS. 4A, 4B and 4C are schematic diagrams of a landing gear mechanism that may be used with the system shown in FIGS. 3A and 3B according to an embodiment of the disclosure.

FIGS. 5A, 5B and 5C are schematic diagrams of aspects of the system shown in FIGS. 3A and 3B according to an embodiment of the disclosure.

FIG. 6 is a flow chart of aspects of the method of FIG. 2 according to an embodiment of the disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

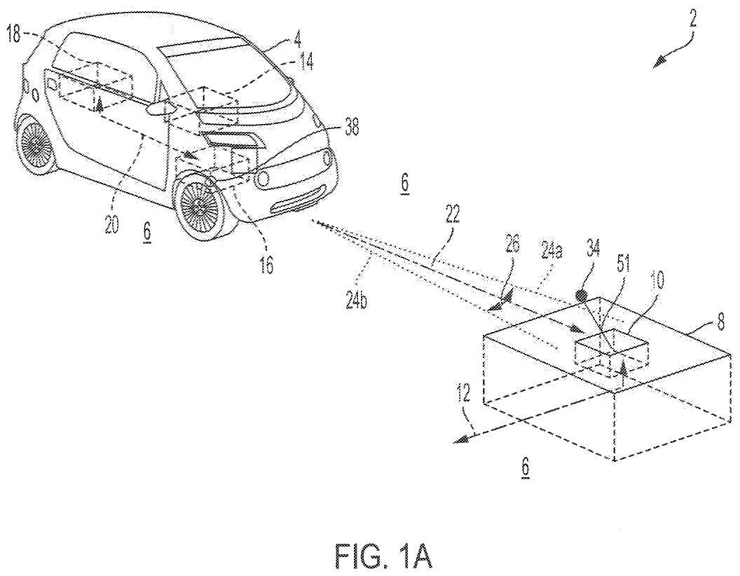

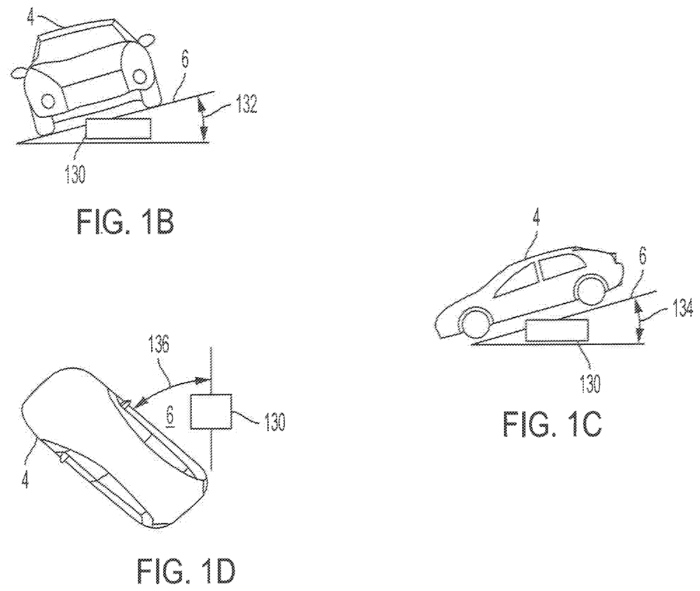

FIG. 1A is a perspective view of an electric vehicle (EV) charging environment 2 according to an embodiment of the disclosure. In the example shown in FIG. 1A, an EV 4 is positioned on a ground surface 6. EV 4 is a car, as shown in FIG. 1A. Alternatively, EV 4 may be a truck, a motorcycle, a moped, a truck or bus, a scooter, a farm implement or any other on-or off-highway vehicle. In the example shown, ground surface 6 is a floor of a garage or other vehicle storage facility of a home or business. Alternatively, ground surface 6 may be a surface of a parking lot. Environment 2 includes a floor unit 8. Floor unit 8 is positioned on or, at least in part, beneath ground surface 6. Depending on application, and also on the ground clearance of the vehicle, the floor unit 8 may be fully or partially disposed beneath the ground surface, or may alternatively be disposed on the ground surface, for example, when installed on existing floors. Floor unit 8 includes a connector unit 10. At least a portion of connector unit 10 faces and is exposed or exposable to ground surface 6. Connector unit 10 of floor unit 8 is operatively coupled to or associated with an electric power source (e.g., a utility grid, not shown in FIG. 1A), either directly or through a transforming, conditioning, and/or conversion device such as a transformer or converter. A first electric power flow 12 can thus be selectively enabled between power source and floor unit 8, including to connector unit 10.

EV 4 includes a drivetrain 14 providing motive power to the EV 4 for driving. EV 4 includes a vehicle unit 16 and at least one power storage device such as a battery 18. Battery 18 is operatively coupled to drivetrain 14 for providing electric power thereto to enable providing motive power for EV 4 selectively during operation. Structures and systems of the EV 4 that accomplish the provision of power to the drivetrain 14 selectively by an operator (not shown) of the EV 4 are omitted for simplicity. At least a portion of a vehicle unit 16 faces and is exposed or exposable to ground surface 6. It is noted that, while the EV 4 is shown in one orientation as it approaches the floor unit 8, any orientation of approach is also contemplated. Vehicle unit 16 is operatively coupled to battery 18 to provide an interface for providing electrical power to charge the battery 18. A second electric power flow 20 is thus enabled between vehicle unit 16 and battery 18.

In the EV charging environment 2 shown in FIG. 1A, EV 4 is being driven and approaches the floor unit 8 including connector unit 10. A driver of EV 4 (e.g., a human driver and/or an autonomous vehicle driving system, not shown in FIG. 1A) steers or otherwise controls the EV 4 to approach floor unit 8 including connector unit 10 along a centerline path 22. As shown in FIG. 1A, centerline path 22 extends from EV 4 to at least approximately a center point of connector unit 10 proximal ground surface 6. Based on the particular dimensions and other specifications of EV 4, floor unit 8 including connector unit 10, and/or vehicle unit 16, an approach path of EV 4 to floor unit 8 including connector unit 10 may deviate from the target centerline path 22 by an allowable deviation 24. The allowable deviation may be in any direction, including but not limited to a horizontal or vertical direction. Allowable deviation 24 includes a driver side deviation 24a and a passenger side deviation 24b, for example. An allowable deviation angle 26 is defined between lines defining driver side deviation 24a and passenger side deviation 24b. In three dimensions, the deviation angle 26 may form a conical area that accounts for height of ground clearance of the vehicle, as well pitch, yaw and roll of the vehicle's trajectory during the approach to the floor unit 8, and also during the connection and charging operations.

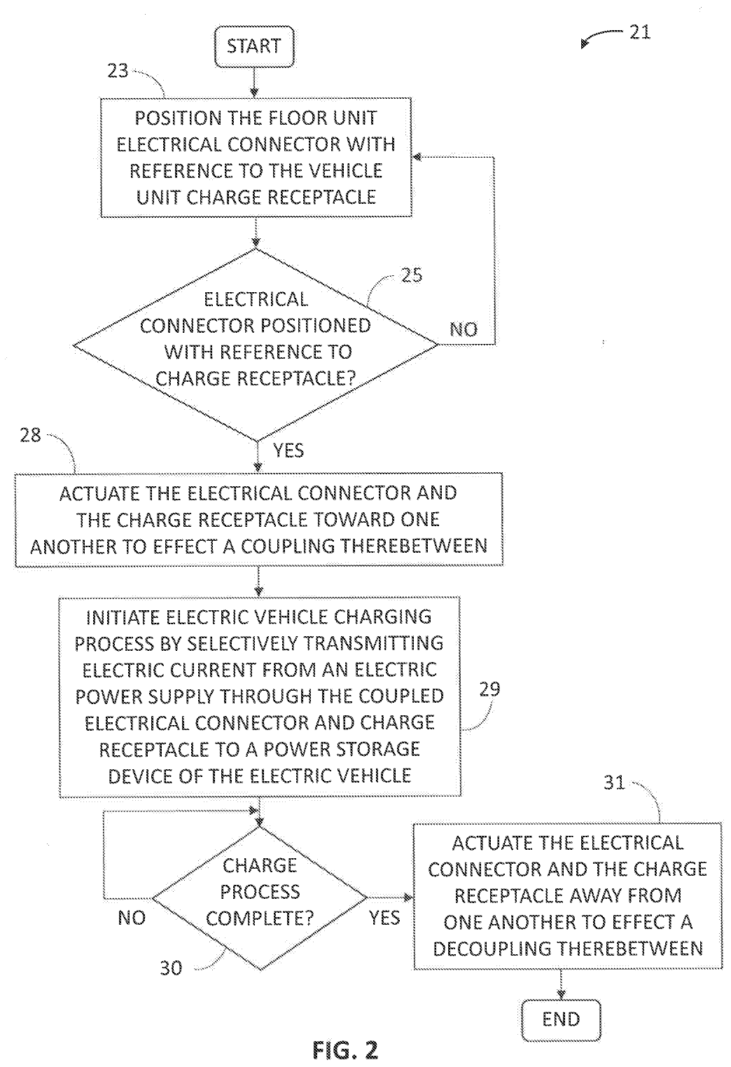

FIG. 2 is flowchart of a method 21 for underside charging of the EV 4 according to an embodiment of the disclosure. In an example, method 21 is implemented and performed, at least in part, by a mechanical linkage system including a floor unit link 51, which rises up from the floor 6 from the connector unit 10 and includes a floor unit electrical connector 34 (as shown in FIG. 1A). The floor unit electrical connector 34 matingly engages a vehicle unit electrical connector 38 (e.g., a charge receptacle) associated with the vehicle unit 16 when the EV 4 is stationary over the floor unit 8 for charging.

Referring to FIG. 2, method 21 includes positioning at 23 the floor unit electrical connector 34 on the floor unit 8 with reference to the mating vehicle unit electrical connector 38 on the EV 4 using the mechanical linkage system 36. Such positioning and/or placement may be carried out automatically. Method 21 further includes actuating at 28 the floor unit 8 electrical connector 34 and the vehicle unit 16 electrical connector 38 toward one another to effect, or at least facilitate, a coupling and/or mating engagement therebetween. The actuating 28 culminates in the floor unit 8 electrical connector 34 being inserted into the vehicle unit 16 electrical connector 38. Alternatively, the vehicle unit 16 electrical connector 38 is inserted at 32 into floor unit 8 electrical connector 34. Such actuating 28 may be performed in response to the electrical connector 34 on the floor unit 8 being positioned 23 with reference to the vehicle unit electrical connector 38 (e.g., charge receptacle) on the EV 4. A state of floor unit 8 connector 34 being positioned 23 with reference to vehicle unit electrical connector 38 may be determined at 25 automatically by, for example, functionality of vehicle unit 16 and/or floor unit 8 such as detecting a signal (e.g., beacon) transmitted by same indicative of EV 4 arriving at, or in proximity to, charging environment 2.

Method 21 includes initiating an EV 4 charging process at 29 (e.g., after the actuating step is performed at 28). When floor unit 34 and vehicle unit 38 electrical connectors are mated, or otherwise safely coupled to one another, and the charging process is initiated at 29, a flow of electrical current is allowed to be transmitted from the floor unit 8 to the vehicle unit 16, and from there to the battery 18 to charge the battery 18. An electrical connection between the connectors 34 and 38 is included in this power flow path that charges the battery 18. As can be appreciated, the operating conditions in which connectors 34 and 38 are present may be harsh because one or both sides of the connectors 34 and 38 are exposed to the environment, road debris, weather (e.g., rain, snow, and ice), etc. Moreover, the connectors 34 and 38 are advantageously compact to enable or facilitate manual and/or automatic coupling for charging the battery 18.

Method 21 further includes actuating at 31 the floor unit 8 electrical connector 34 and the vehicle unit 16 electrical connector 38 away from one another to effect, or at least facilitate, a decoupling and/or disengagement therebetween. The actuating 31 culminates in the floor unit 8 electrical connector 34 being removed from the vehicle unit 16 electrical connector 38. Alternatively, the vehicle unit 16 electrical connector 38 is removed at 32 from floor unit 8 electrical connector 34. Such actuating 31 may be performed in response to a presence of one or more conditions representative of completion of the EV 4 charging process. The condition(s) representative of completion of the EV 4 charging process may be determined at 30 automatically by, for example, functionality of vehicle unit 16 and/or floor unit 8 such as directly or indirectly detecting one or more operating parameters of battery 18 (e.g., current, voltage, state of charge, etc.). The actuating step may be performed at 31 following a cessation of the flow of current from the floor unit 8 to the vehicle unit 16.

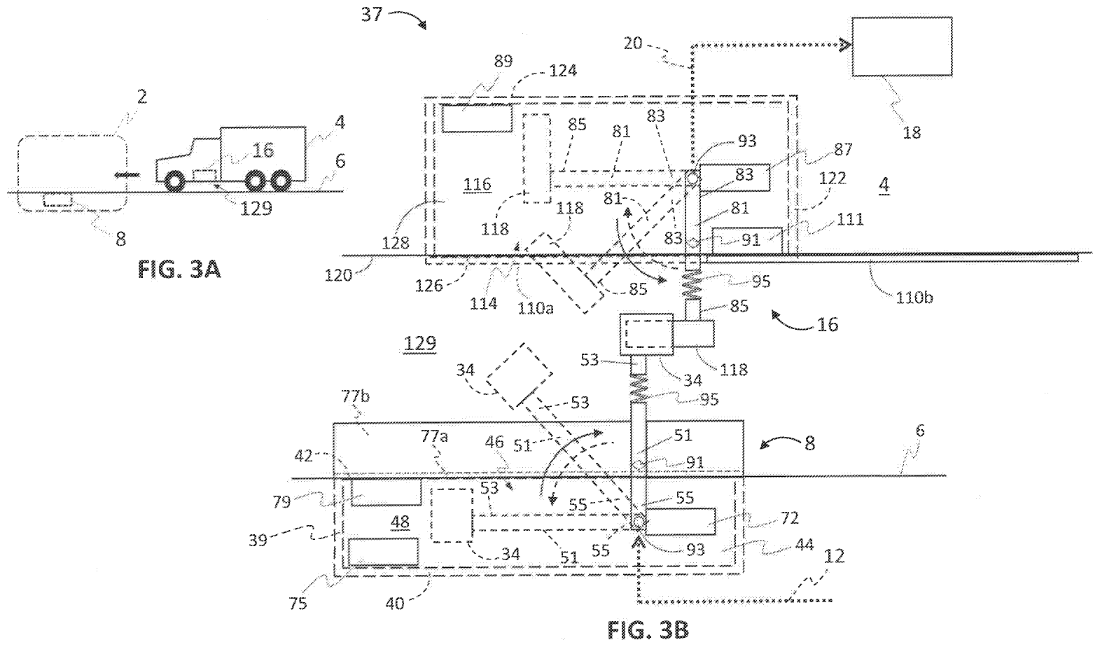

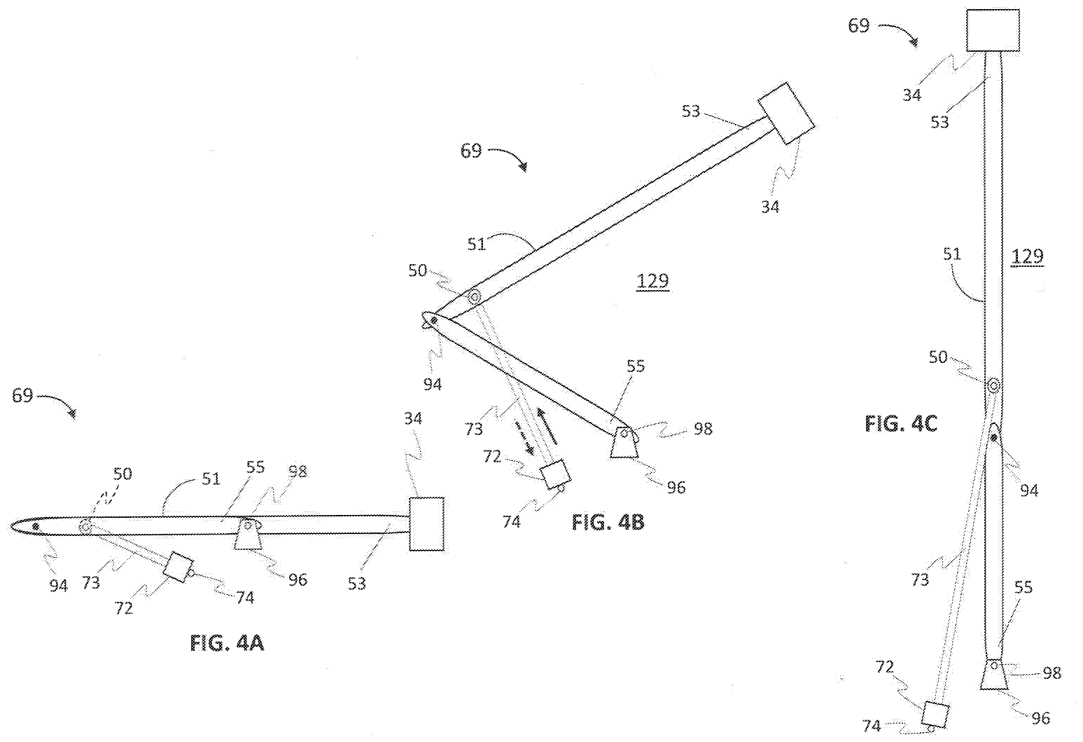

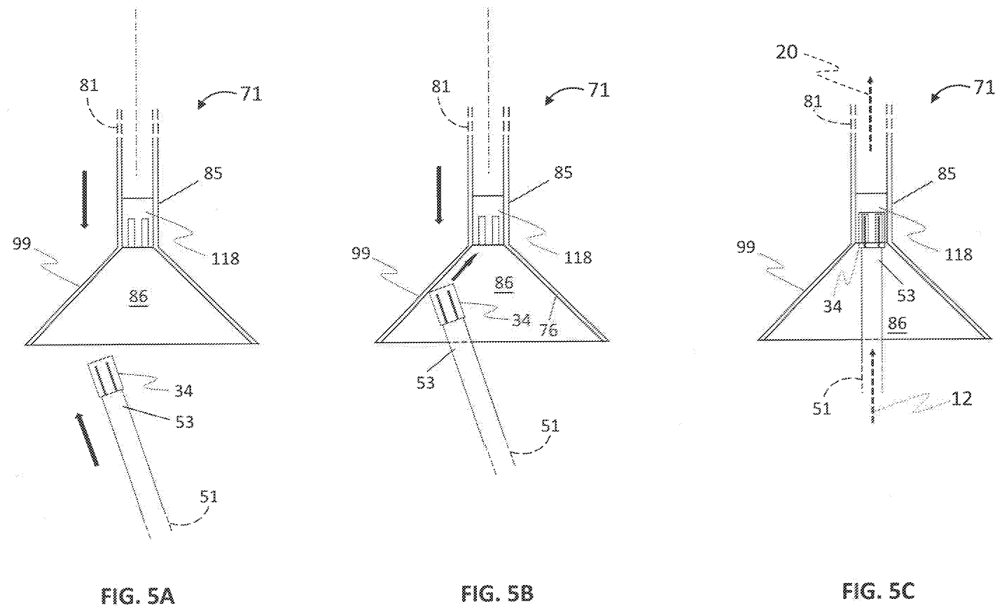

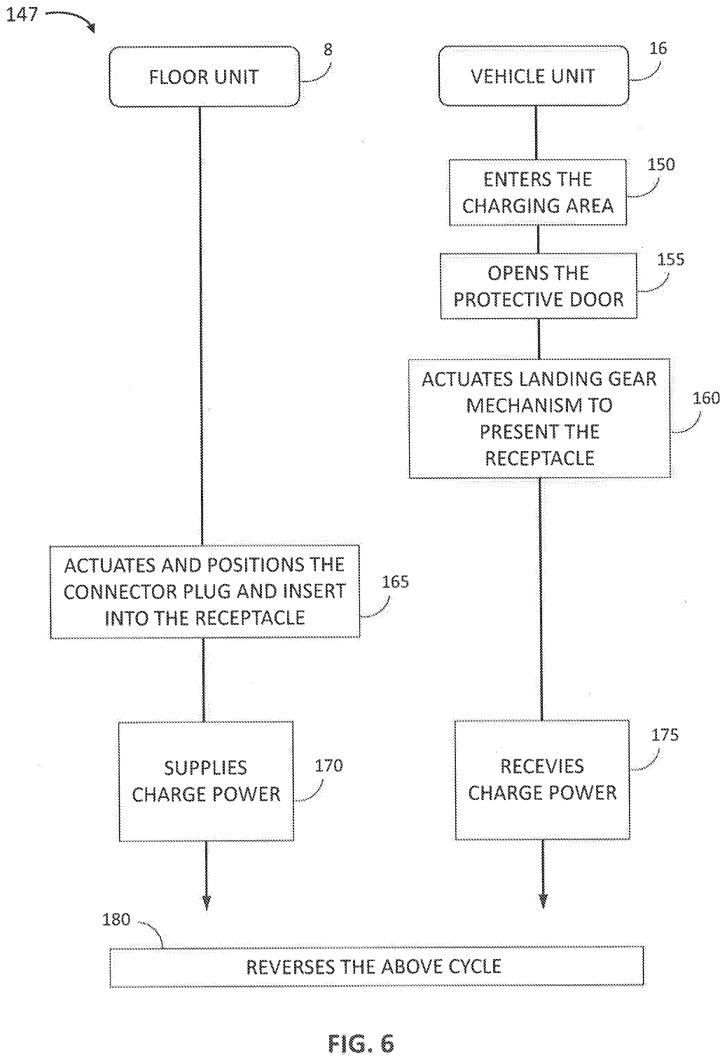

Embodiments of devices and systems for underside charging of EVs 4 are shown in FIGS. 3A-6 and described below. FIGS. 3A and 3B are schematic diagrams of a modular system 37 which may be used to implement, at least in part, the method 21 for underside charging of EVs 4 in accordance with the disclosure. FIG. 3B illustrates a sequence of positions of components of floor unit 8 and vehicle unit 16 during a sequence of operational steps of method 21. FIGS. 4A-4C are schematic diagrams of a landing gear mechanism 69 that may be used with the system 37 of FIGS. 3A and 3B in accordance with the disclosure. FIGS. 4A-4C illustrate a sequence of positions of components of the landing gear mechanism 69 during a sequence of operational steps of method 21. FIGS. 5A-5C are schematic diagrams of an electrical connection mechanism 71 that may be used with the system 37 of FIGS. 3A and 3B. FIGS. 5A-5C illustrate a sequence of positions of components of the electrical connection mechanism 71 during a sequence of operational steps of method 21. FIG. 6 is a flow chart of a process 147 for underside changing of EVs 4 that may be used with the system 37 of FIGS. 3A and 3B and with the method 21 of FIG. 2.

Referring to FIGS. 3A and 3B, modular system 37 is utilized for charging EVs 4 in charging environment 2 having the ground surface 6, and the EV 4 includes an EV underside 120 positioned opposite the ground surface 6. System 37 includes the floor unit device 8 (also referred to herein as “floor unit 8”) positioned on or at least partially in the ground surface 6. Floor unit 8 includes a floor unit link 51 having distal 53 and proximal 55 ends. Electrical connector 34 is operably coupled to the floor unit link 51 proximal the distal end 53 thereof. By way of one or more wires or other conductors (not shown), connector 34 is electrically coupled to the power source (e.g., utility grid) positioned outside of the EV 4, as shown in FIG. 1A.

Floor unit 8 includes at least one floor unit actuator 72 operably coupled to the floor unit link 51 proximal the proximal end 55 thereof. Floor unit actuator(s) 72 and components for use in operably coupling actuator(s) 72 to link 51 may be of one or more types and/or configurations including, for example and without limitation, linear and/or rotational actuators, electric motors, and/or pneumatic cylinders. By way of example only, the floor unit actuator 72 and the proximal end 55 of the floor unit link 51 shown in FIG. 3B are rotatably coupled to one another using a coupling 93. When actuated at, for example, steps 28 and/or 31 of method 21, the floor unit actuator 72 causes the floor unit link 51 to alternately move toward and away from the EV 4 to facilitate alternately connecting and disconnecting the connector 34 from a charge receptacle.

Floor unit 8 includes a frame 39 having a base 40 and an at least partially open top side 42 positioned opposite the base 40. Frame 39 has at least one side wall 44 extending between the base 40 and the top side 42. The base 40, the at least one side wall 44, and the top side 42 define a hollow frame cavity 48 having an opening 46 in the top side 42. The frame 39 houses the floor unit link 51 and the electrical connector 34.

Floor unit 8 includes at least one door 77 operably coupled to at least a portion of the frame 39. In the example shown in FIG. 3B, door(s) 77 are rotatably coupled to frame 39 using one or more hinges. In other examples (not shown), door(s) 77 are slidingly engaged with frame 39 by way of linear slide(s) coupled to frame 39. At least one door actuator 79 is positioned proximal at least a portion of the door 77 for alternately moving door 77 between closed 77a and open 77b positions. Door(s) 77 at least partially selectively cover the opening 46 of frame 39 to thereby at least partially enclose the frame 39 under action of the door actuator 79. In another embodiment, not shown in FIG. 3B, the door actuator 79 is or includes the floor unit actuator 72. In such embodiments, the functionality of the door actuator 79 is implemented, at least in part, by the floor unit actuator 72. In operation, door(s) 77 are opened to enable the floor unit 8 to be exposed to an EV-to-ground surface space 129 for use in method 21. Thus, door 77 may be opened in response to EV 4 approaching and/or entering charging environment 2, and otherwise kept closed so as to provide protection from exterior elements.

System 37 includes the vehicle unit device 16 (also referred to herein as “vehicle unit 16”) positioned on or at least partially in the EV underside 120. Vehicle unit 16 includes a vehicle unit link 81 having distal 83 and proximal 85 ends. Electrical connector 38 of vehicle unit 16 may be a charge receptacle 118 operably coupled to the vehicle unit link 81 proximal the proximal end 85 thereof. By way of one or more wires or other conductors (not shown), charge receptacle 118 is electrically coupled to the EV4 battery 18, as shown in FIG. 1A.

Vehicle unit 16 includes at least one vehicle unit actuator 87 operably coupled to the vehicle unit link 81 proximal the distal end 83 thereof. Vehicle unit actuator(s) 87 and components for use in operably coupling actuator(s) 87 to link 81 may be of one or more types and/or configurations including, for example and without limitation, linear and/or rotational actuators, electric motors, and/or pneumatic cylinders. By way of example only, the vehicle unit actuator 87 and the proximal end 83 of the vehicle unit link 81 shown in FIG. 3B are rotatably coupled to one another using a coupling 93. When actuated at, for example, steps 28 and/or 31 of method 21, the vehicle unit actuator 87 causes the vehicle unit link 81 to alternately move away from and back toward the EV 4 to facilitate alternately connecting and disconnecting the charge receptacle 118 from the connector 34. In an equivalent, or at least analogous, manner, as used in method 21, floor unit 72 and vehicle unit 87 actuators of system 37 alternately move the floor unit 51 and vehicle unit 81 links toward and away from one another to facilitate alternately connecting and disconnecting the connector 34 to and from the charge receptacle 118, respectively.

Vehicle unit 16 includes a frame 122 having a base 124 and an at least partially open cover side 126 positioned opposite the base 124. Frame 122 has at least one side wall 128 extending between the base 124 and the cover side 126. The base 124, the at least one side wall 128, and the cover side 126 define a hollow frame cavity 116 having an opening 114 in the cover side 126. The frame 122 houses the vehicle unit link 81 and the charge receptacle 118.

Vehicle unit 16 includes at least one door 110 operably coupled to at least a portion of the frame 122. In the example shown in FIG. 3B, door(s) 110 are slidingly engaged with frame 122 by way of linear slide(s) coupled to frame 122. In other examples (not shown), door(s) 110 are rotatably coupled to frame 122 using one or more hinges. At least one door actuator 111 is positioned proximal at least a portion of the door 110 for alternately moving door 110 between closed 110a and open 110b positions. Door(s) 110 at least partially selectively cover the opening 114 of frame 122 to thereby at least partially enclose the frame 122 under action of the door actuator 111. In another embodiment, not shown in FIG. 3B, the door actuator 111 is or includes the vehicle unit actuator 87. In such embodiments, the functionality of the door actuator 111 is implemented, at least in part, by the vehicle unit actuator 87. In operation, door(s) 110 are opened to enable the vehicle unit 16 to be exposed to the EV-to-ground surface space 129 for use in method 21. Thus, door 110 may be opened in response to EV 4 approaching and/or entering charging environment 2, and otherwise kept closed so as to provide protection from exterior elements.

System 37 includes one or more actuator controllers (e.g., floor unit 75 and vehicle unit 89 actuator controllers) operably coupled to and/or in communication with the floor unit 72 and vehicle unit 87 actuators. In the example shown in FIG. 3B, actuator controllers 75 and 89 are positioned in respective frames 39 and 122 as separate components from actuators 72 and 87. In another example (not shown), actuator(s) 72 and/or 87 include respective actuator controller(s) 75 and 89 providing control functionality integrated within the respective actuator(s) 72 and/or 87, so as to reduce an amount of space occupied by components of floor unit 8 and/or vehicle unit 16, as well as minimize the weight thereof.

As implemented in system 37 for use in method 21, for example, floor unit actuator controller 75 causes the floor unit actuator 72 to move link 51 toward the EV 4 in response to the connector 34 being positioned 23 (e.g., at or proximal to a first location or range of locations in charging environment 2) with reference to the charge receptacle 118. Actuator controller 75 may further cause the floor unit actuator 72 to move the connector 34 toward the charge receptacle 118 to effect, or at least facilitate, the coupling therebetween. Likewise, vehicle unit actuator controller 89 causes the vehicle unit actuator 87 to move link 81 toward the ground surface 6 in response to the charge receptacle 118 being positioned 23 (e.g., at or proximal to a second location or range of locations in charging environment 2) with reference to the connector 34. Actuator controller 89 may further cause the vehicle unit actuator 87 to move the charge receptacle 118 toward the connector 34 to effect, or at least facilitate, coupling therebetween.

In method 21, actuator controller(s) 75 and/or 89 may include digital and/or analog electronic components which, in conjunction with, for instance, sensors (not shown) included as components of and/or in communication with actuator controller(s) 75 and/or 89, enable system 37 to determine, at 25 of method 21, that the connector 34 is positioned with reference to the charge receptacle 118. Sensors facilitating this determination in method 21 may be positioned proximal controller 75 and/or 89 and/or elsewhere in environment 2, such as in or on EV 4. Instead of, or in addition to, sensors facilitating the determination, at 25 of method 21, system 37 may utilize wireless communication such as radio wave, light, magnetic, or electric fields, of the use of sound. Such wireless communication may be used in the disclosed systems and methods, for example and without limitation, to detect and/or otherwise facilitate positioning of the EV 4, hand-shaking of connect/disconnect of electrical connectors (e.g., connector 34 to/from receptacle 118), and start/end of charging cycle.

Either or both of actuator controllers 75 and 89 may be further operably coupled to and/or in communication with the floor unit 79 and vehicle unit 111 door actuators. Floor unit actuator controller 75 causes the floor unit door actuator 79 to alternately move the door 77 from the closed 77a to the open 77b position concurrently with the floor unit link 51 being alternately moved by actuator 72 toward and away from EV 4, respectively. In embodiments in which actuators 72 and 79 are the same component in floor unit 8, actuators 72 and 79 simultaneously move both door 77 and link 51. Likewise, vehicle unit actuator controller 89 causes the vehicle unit door actuator 11 to alternately move the door 110 from the closed 110a to the open 110b position concurrently with the vehicle unit link 81 being alternately moved by actuator 87 away from and toward EV 4, respectively. In embodiments in which actuators 87 and 111 are the same component in vehicle unit 16, actuators 87 and 111 simultaneously move both door 110 and link 81.

As shown in FIG. 3B, from a fully retracted state of link 51 and connector 34 at rest and positioned in frame 39, floor unit actuator(s) 72 under control of actuator controller(s) 75 cause link 51 and connector 34 to move through intermediate positions through space 129 or along EV underside 120 to an at least partially erect position with connector 34 ultimately mated with or otherwise coupled to charge receptacle 118. Depending on a final position of charge receptacle 118 in space 129, the final position of connector 34 in space 129 may correspond to a fully erect position of link 51, or may correspond to link 51 positioned at an angle having a magnitude greater than 0° (zero degrees) with respect to a normal line drawn from ground surface 6. Before and/or concurrently with movement of link 51 and connector 34 by actuator 72, door actuator(s) 79 under control of actuator controller(s) 75 cause door 77 to move from a restful state in the closed 77a position through intermediate positions (e.g., through space 129 or along ground surface 6) to the open 77b position. Opening of the door 77 thereby provides a clear path of movement to enable link 51 and connector 34 to transit out of frame 39 and into space 129 or along ground surface 6 during performance of method 21.

Similarly, from a fully retracted state of link 81 and charge receptacle 118 at rest and positioned in frame 122, vehicle unit actuator(s) 87 under control of actuator controller(s) 89 cause link 81 and charge receptacle 118 to move through intermediate positions through space 129 or along EV underside 120 to a final position with charge receptacle 118 ultimately mated with or otherwise coupled to connector 34. Depending on a final position of connector 34 in space 129, the final position of charge receptacle 118 in space 129 may correspond to a fully erect position of link 81, or may correspond to link 81 positioned at an angle having a magnitude greater than 0° with respect to a normal line drawn from EV underside 120. Before and/or concurrently with movement of link 81 and charge receptacle 118 by actuator 87, door actuator(s) 111 under control of actuator controller(s) 89 cause door 110 to move from a restful state in the closed 110a position through intermediate positions (e.g., through space 129 or along EV underside 120) to the open 110b position. Opening of the door 110 thereby provides a clear path of movement to enable link 81 and charge receptacle 118 to transit out of frame 122 and into space 129 or along EV underside 120 during performance of method 21.

Floor unit actuator controller 75 and/or vehicle unit actuator controller 89 cause, or at least facilitate, the initiation of the EV 4 charging process at, for example, step 29 of method 21. In the example shown in FIG. 3B, controllers 75 and/or 89 selectively and alternately enable and disable the flow of electrical current (12, 20) from the power supply through the coupled connector 34 and charge receptacle 118 to the EV 4 power storage device (e.g., battery 18). The flow of electrical current (12, 20) may be enabled immediately upon the coupling of connector 34 to charge receptacle 118 as, for instance, the conductor in floor unit 8 which is electrically coupled to connector 34 being in an energized state prior to the coupling. Alternatively, the flow of electrical current (12, 20) may be enabled after the coupling of connector 34 to charge receptacle 118 as, for example and without limitation, the conductor in floor unit 8 which is electrically coupled to connector 34 being caused to be energized by controller(s) 75 and/or 89 (e.g., using a switch) after a predetermined amount of time has elapsed after the coupling.

Referring to FIGS. 4A-4C, floor unit 8 may include the link 51, connector 34, and actuator 72 assembled as a landing gear mechanism 69. In mechanism 69, actuator 72 is or includes a linear actuator having an actuating arm or rod 73, with actuator 72 rotatably coupled to frame 39 (not shown) by way of an actuator coupling 74, and with arm or rod 73 rotatably coupled to link 51 by way of an arm or rod coupler 50. In the example shown in FIGS. 4A-4C, link 51 is a two-piece subassembly of mechanism 69, with each of the two parts or pieces of link 51 rotatably coupled to each other by way of a link coupler 94, and with the proximal end 55 of link 51 rotatably coupled to frame 39 by way of a mount 96 and associated hinge 98.

FIG. 4A illustrates the landing gear mechanism 69 in the fully retracted position at rest in frame 39. As such, the linear actuator 72 arm or rod 73 is also in its fully retracted position. Under control of actuator controller 75, linear actuator 72 causes the arm or rod 73 to move outward from actuator 72 in the indicated direction, thereby exerting a force upon link 51 at the position of the arm or rod coupler 50. The force results in movement of mechanism 69 from the fully retracted position out of frame 39 and through intermediate positions (e.g., as shown in FIG. 4B) through space 129 to an at least partially erect position (e.g., as shown in FIG. 4C).

In another embodiment, the landing gear mechanism 69 and its associated operation, as shown in FIGS. 4A-4C may be incorporated into the vehicle unit 16 instead of, or in addition to, being used in floor unit 8. As compared to the embodiments shown in FIG. 3B, the landing gear mechanism 69 of FIGS. 4A-4C may occupy less space in the floor unit 8 and/or the vehicle unit 16. In either the one piece link configuration of FIG. 3B or the two-piece configuration of FIGS. 4A-4C, the floor unit 8 and/or vehicle unit 16 landing gear mechanism(s) for EV 4 charging is/are compatible for use with the disclosed systems and methods.

In system 37, floor unit 51 and/or vehicle 81 links may include various compliance devices operably coupled thereto. Such compliance devices may include, for example, and without limitation, one or more joints 91, hinges, and/or springs 95, that facilitate effecting the coupling between the connector 34 and the charge receptacle 118. Inclusion of one or more compliance devices in system 37 compensates for misalignment of connector 34 and charge receptacle 118 which may occur at, for instance, steps 23, 25, 28 and/or 31 of method 21. Similarly, compliance devices may prevent, or at least mitigate, damage to floor 8 and/or vehicle 16 unit components in cases of EV 4 accidentally striking at least a portion of floor unit 8 such as connector 34, link 51, and/or actuator 72.

Compliance devices of system 37 may include other types of devices instead of, or in addition to joint(s) 91, hinge(s) 93, and/or spring(s) 95. Additionally, or instead of, system 37 may include mating guides such as a conical-, frustoconical-, or square-, pyramidal-, or polygonal-frustum-shaped guide piece 99. FIGS. 5A-5C illustrate a square-frustum-shaped guide piece 99 in cross section, with its smaller area cutting plane coupled to the proximal end 85 of link 81, and with the larger of its two cutting planes positioned proximally from charge receptacle 118. FIG. 5A depicts a misalignment of vehicle unit 8 link 51 with respect to a longitudinal axis of vehicle unit 16 link 81. Although such misalignments should be exceedingly rare during operation of system 37, if they occur, for instance, during performance steps 23, 28, and/or 31 of method 21, inclusion of guide piece 99 facilitates safe and successful coupling and decoupling between connector 34 and charge receptacle 118. As used in method 21, charge receptacle 118 may be moving toward connector 34 simultaneously with connector 34 moving toward receptacle 118. Alternatively, in method 21, charge receptacle 118 or connector 34 may be stationary during such times when connector 34 or charge receptacle 118, respectively, is undergoing movement. Absent other corrective measures being taken, without the inclusion of guide piece 99 in system 37, the illustrated misalignment could lead to the connector 34 missing its connection with receptacle 118.

As shown in FIG. 5B, rather than connector 34 missing the receptacle 118, connector 34 enters an interior space 86 of guide piece 99 and contacts an interior side wall 76 thereof. As a result of movement of either or both of link 81 and link 51, connector 34 traverses side wall 76 and moves closer to receptacle 118. Both connector 34 and charge receptacle 118 then matingly engage or otherwise couple to one another, as shown in FIG. 5C, and system 37 thereby attains a state of dynamic equilibrium or is otherwise readied for performance of step 29 in method 21. In an equivalent, or at least analogous manner as shown and described with reference to FIGS. 5A-5C, and with at least some of the attendant operational advantages, guide piece 99 may instead be positioned on the floor unit 8 side of system 37, with its smaller area cutting plane coupled to the distal end 53 of link 51, and with the larger of its two cutting planes positioned distally from connector 34.

As used, for instance, with system 37 and method 21, the compliance devices described herein facilitate the coupling and decoupling of connector 34 to and from charge receptacle 118 in case where EV 4 is positioned in charging environment 2 at varying degrees of pitch (e.g., about the y-axis, as shown in FIG. 1C), yaw (e.g., about the z-axis, as shown in FIG. 1D), and/or roll (e.g., about the x-axis, as shown in FIG. 1B), and at varying heights of the vehicle unit device 16 with respect to the floor unit device 8. Alternative, or additional system 37 configurations for floor unit 8, and compatible components providing compliance in such operational use cases, and which are analogously applicable, at least in part, to either floor unit 8 or vehicle unit 16, are provided in U.S. patent application Ser. No. 16/182,033, which is incorporated by reference herein in its entirety to the extent it is not inconsistent with the present disclosure.

Referring to FIG. 6, process 147 flow chart summarizes embodiments of the above-described systems (e.g., system 37) and methods (e.g., method 21) for underside charging of EVs 4. At block 150, EV 4 having vehicle unit 16 enters the charging area of the charging environment 2. Either concurrently with, or prior to, vehicle unit 16 actuator controller 89 causing link 81 and charge receptacle 118 (e.g., in the landing gear mechanism 69 included in vehicle unit 16) to be moved by actuator 87 away from EV 4 and toward floor unit 8 at process 147 block 160, at block 155, actuator controller 89 causes door 110 to be moved from the closed 110a to the open 110b position.

At block 165 of process 147, and either concurrently with, or prior to, floor unit 8 actuator controller 75 causing causes door 77 to be moved from the closed 77a to the open 77b position, actuator controller 75 causes link 51 and connector 34 (e.g., in the landing gear mechanism 69 included in floor unit 8) to be moved by actuator 72 away from ground surface 6 and toward vehicle unit 16, actuator controller 75. Following the mating engagement or otherwise coupling between connector 34 and charge receptacle 118, the flow of electric current (12, 20) is initiated at, for instance, step 29 of method 21. During this flow (12, 20), charge power is supplied to, and received by, battery 18 of EV 4 in process 147 blocks 170 and 175, respectively.

Method 21 operations using system 37 proceed in process 147 blocks 170 and 175 until such time that the EV 4 charging process (e.g., process 147) is complete and/or EV 4 is readied to leave the charging environment 2. In, for instance, step 30 of method 21, actuator controller(s) 75 and/or 89 determine whether or not condition(s) representative of completion of the EV 4 charging process (e.g., process 147) are present. In response to those condition(s) being present, process 147 proceeds to block 180 to perform the remaining method 21 steps in a reverse process 147 sequence.

In response to the one or more conditions representative of completion of the EV (4) charging process 147 being present, actuator controller(s) 75 and/or 89 cause actuators (72, 87) to move the connector 34 and charge receptacle 118 away from one another to effect, or at least facilitate, decoupling therebetween. For this, actuator controller(s) 75 and/or 89 cause actuators (72, 87) to move floor unit 51 and vehicle unit 81 links away from one another in response to a presence of the condition(s) representative of completion of an EV 4 charging process.

Either concurrently with, or prior to, actuator controller(s) 75 and/or 89 causing link 51 and connector 34 (e.g., in the landing gear mechanism 69 included in floor unit 8) to be moved by actuator 72 away from EV 4 and back toward floor unit 8 in process 147 actuator controller(s) 75, 89, and/or 79 cause(s) door 77 to be moved from the open 77b to the closed 77a position. Likewise, and either concurrently with, or prior to, actuator controller(s) 75 and/or 89 causing link 81 and charge receptacle 118 (e.g., in the landing gear mechanism 69 included in vehicle unit 16) to be moved by actuator 87 away from floor unit 8 and back toward EV 4 in process 147, actuator controller(s) 75, 89, and/or 111 cause(s) door 110 to be moved from the open 110b to the closed 110a position.

The above-described systems and methods for underside charging of EVs provide space- and weight-efficient mechanisms for efficient, reliable and safe charging operations. As compared to known systems and methods, the embodiments disclosed herein provide a number of technical benefits and user advantages in a wide variety of operational environments ranging from home use to commercial contexts. By employing simple yet robust components and other design elements, the disclosed systems and methods for underside charging or EVs are easy to maintain and they may be cost-effectively retrofitted into existing electric vehicles and facilities.

Various embodiments disclosed herein are to be taken in the illustrative and explanatory sense, and should in no way be construed as limiting of the present disclosure.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A floor unit device for charging of an electric vehicle (EV), the device comprising:
a floor unit link having distal and proximal ends;
an electrical connector operably coupled to the floor unit link proximal the distal end thereof, and electrically coupled to a power source positioned outside of the EV; and
a floor unit actuator operably coupled to the floor unit link proximal the proximal end thereof,
wherein the floor unit actuator is configured to alternately move the floor unit link toward and away from the EV to facilitate alternately connecting and disconnecting the connector from a charge receptacle of the EV.

2. The device of claim 1 further comprising an actuator controller operably coupled to the floor unit actuator, wherein the actuator controller is configured to cause the actuator to move the link toward the EV in response to the connector being positioned with reference to the charge receptacle.

3. The device of claim 2, wherein the actuator controller is further configured to move the connector toward the charge receptacle to facilitate a coupling therebetween.

4. The device of claim 2, wherein the actuator controller is further configured to cause the actuator to move the link away from the EV in response to a presence of one or more conditions representative of completion of an EV charging process.

5. The device of claim 4, wherein the actuator controller is further configured to cause the actuator to move the connector and charge receptacle away from one another to facilitate a decoupling therebetween.

6. The device of claim 2, wherein the floor unit device is positioned on or at least partially in a ground surface, and wherein the floor unit device further comprises:
a frame having an opening in at least one side thereof, wherein the frame is configured to house the floor unit link and the connector;
a door operably coupled to at least a portion of the frame; and
a door actuator operably coupled the actuator controller,
wherein the door is configured to at least partially selectively cover the opening to thereby at least partially enclose the frame under action of the door actuator.

7. The device of claim 6, wherein the actuator controller is further configured to cause the door actuator to alternately move the door from a closed to an open position concurrently with the floor unit link being alternately moved by the actuator toward and away from the EV, respectively.

8. The device of claim 6, wherein the door actuator is or includes the floor unit actuator.

9. A system for charging of an electric vehicle (EV) in an EV charging environment having a ground surface, the EV including an EV underside positioned opposite the ground surface, the system comprising:
a floor unit device positioned on or at least partially in the ground surface, and comprising:
a floor unit link having distal and proximal ends;
an electrical connector operably coupled to the floor unit link proximal the distal end thereof, and electrically coupled to a power source positioned outside of the EV; and
a floor unit actuator operably coupled to the floor unit link proximal the proximal end thereof; and
a vehicle unit device positioned on or at least partially in the EV underside, and comprising:
a vehicle unit link having distal and proximal ends;
a charge receptacle operably coupled to the vehicle unit link proximal the proximal end thereof, and electrically coupled to a power storage device of the EV; and
a vehicle unit actuator operably coupled to the vehicle unit link proximal the distal end thereof,
wherein the floor unit and vehicle unit actuators are configured to alternately move the floor unit and vehicle unit links toward and away from one another to facilitate alternately connecting and disconnecting the connector to and from the charge receptacle, respectively.

10. The system of claim 9 further comprising one or more actuator controllers operably coupled to the floor unit and vehicle unit actuators, wherein the one or more actuator controllers are configured to:
determine the connector being positioned with reference to the charge receptacle; and
in response to the connector being positioned with reference to the charge receptacle, cause the actuators to move the connector and charge receptacle toward one another to facilitate a coupling therebetween.

11. The system of claim 10, wherein the one or more actuator controllers are further configured to initiate an EV charging process by selectively enabling a flow of electric current from the power supply through the coupled connector and charge receptacle to the power storage device.

12. The system of claim 10, wherein the one or more actuator controllers are further configured to:
determine a presence of one or more conditions representative of completion of the EV charging process; and
in response to the one or more conditions representative of completion of the EV charging process being present, cause the actuators to move the connector and charge receptacle away from one another to facilitate a decoupling therebetween.

13. The system of claim 10, wherein the vehicle unit further comprises:
a frame having an opening in at least one side thereof, wherein the frame is configured to house the vehicle unit link and the charge receptacle;
a door operably coupled to at least a portion of the frame; and
a door actuator operably coupled to the one or more actuator controllers, wherein the door is configured to at least partially selectively cover the opening to thereby at least partially enclose the frame under action of the door actuator.

14. The system of claim 13, wherein the one or more actuator controllers are further configured to cause the door actuator to alternately move the door from a closed to an open position concurrently with the floor unit and vehicle unit links being alternately moved by the actuators toward and away from one another, respectively.

15. The system of claim 13, wherein the door actuator is or includes the vehicle unit actuator.

16. The system of claim 10, wherein at least one of the floor unit and vehicle unit links includes at least one of: a joint, a hinge, and a spring, to further facilitate the coupling between the connector and the charge receptacle.

17. The system of claim 9, wherein at least one of the floor and vehicle units includes at least one of: a joint, a hinge, and a spring, operably coupled to at least one of: the floor unit link, the vehicle unit link, the floor unit frame, and the vehicle unit frame, to further facilitate alternately connecting and disconnecting the connector to and from the charge receptacle, respectively.

18. The system of claim 17, wherein the at least one of: the joint, the hinge, and the spring, further facilitates alternately connecting and disconnecting the connector to and from the charge receptacle, respectively, by accommodating varying pitch, yaw, roll, or height of the vehicle unit device with respect to the floor unit device.

19. A method for charging of an electric vehicle (EV), comprising:
positioning a floor unit electrical connector with reference to a vehicle unit charge receptacle;
in response to the connector being positioned with reference to the charge receptacle, actuating the connector and charge receptacle toward one another to facilitate a coupling therebetween; and
initiating an EV charging process by selectively enabling a flow of electric current from an electric power supply through the coupled connector and charge receptacle to a power storage device of the EV.

20. The method of claim 19 further comprising, in response to a presence of one or more conditions representative of completion of the EV charging process, actuating the connector and charge receptacle away from one another to facilitate a decoupling therebetween.
